(19) United States
(12) Patent Application Publication
(10) Pub. No.: US 2026/0184862 A1
(43) Pub. Date: Jul. 2, 2026

(54) MOISTURE CURABLE SILICON POLYOLEFIN POLYMER AND PROCESS

(71) Applicant: Dow Global Technologies LLC, Midland, MI (US)

(72) Inventors: Shuqi Lai, Midland, MI (US); Zachary S. Kean, Midland, MI (US); Ryan Maar, Midland, MI (US); David S. Laitar, Midland, MI (US); Bethany M. Neilson, Manvel, TX (US)

(21) Appl. No.: 18/868,516

(22) PCT Filed: May 22, 2023
(86) PCT No.: PCT/US2023/023112

§ 371 Date: Nov. 22, 2024

Related U.S. Application Data
(60) Provisional application No. 63/347,087, filed on May 31, 2022.

(51) Int. Cl. C08J 3/24; C08F 8/00

(52) U.S. Cl. CPC C08J 3/244; C08F 8/00; C08F 2810/20; C08F 2810/50; C08J 2323/20

(57) ABSTRACT

The present disclosure provides a process. In an embodiment, the process includes first melt blending, at a temperature from 80° C. to 200° C., a first composition. The first composition is composed of (i) an ethylene-SiH polymer, (ii) a coagent that is a monoketone, and (iii) a triarylborane. The process includes forming a functionalized ethylene-Si polymer. The process further includes second melt blending, at a temperature from 80° C. to 200° C., a second composition. The second composition is composed of (iv) the functionalized ethylene-Si polymer, and (v) a cure catalyst. The process includes moisture curing the second composition, and forming a crosslinked ethylene-Si polymer. The present disclosure also includes a functionalized ethylene-Si polymer composition made from the present process.

Cure of polyolefin materials is often accomplished by a) peroxide cure, b) platinum (Pt)-catalyzed hydrosilylation when silicon hydride (SiH) or vinyl group (C═C) is available, or c) moisture cure in the presence of a condensation catalyst when hydrolysable groups such as alkoxysilane (—Si(OR)₃) or hydridosilane (—SiHR₂) are available. Both a) and b) require a high temperature to initiate the cure process. The application of b) is disfavored due to the high cost of Pt-based catalysts. In c), alkoxysilane is often installed onto polyolefin via a radical process, which follows polymerization and is inevitably accompanied by chain scission and cure of the polymer backbone. Alternatively, alkoxysilane-functionalized polyolefin is synthesized by copolymerization of ethylene and an unsaturated silane (e.g., vinyltrimethoxysilane), which limits the material selection to mostly low density polyethylene (LDPE). Meanwhile, high moisture sensitivity of alkoxysilane necessitates a drying step to keep a low moisture content in ingredients and prevent premature crosslinking. Compared to alkoxysilane, the SiH group on an olefin/silane interpolymer shows higher hydrolytic stability, which affords improved storage stability but meanwhile results in slow cure kinetics even when exposed to a high temperature and a high humidity level.

Therefore, the art recognizes the need to devise new cure reactions of olefin-based polymers that are efficient and economically viable. A need further exists for reactions that can install readily hydrolysable groups to a broad range of polyolefin materials with few, or no, side reactions, the hydrolysable groups providing the ability to cure the functionalized polyolefin at ambient temperature (room temperature).

### SUMMARY

The present disclosure provides a process. In an embodiment, the process includes first melt blending, at a temperature from 80° C. to 200° C., a first composition. The first composition is composed of (i) an ethylene-SiH polymer, (ii) a coagent that is a monoketone, and (iii) a triarylborane. The process includes forming a functionalized ethylene-Si polymer. The process further includes second melt blending, at a temperature from 80° C. to 200° C., a second composition. The second composition is composed of (iv) the functionalized ethylene-Si polymer, and (v) a cure catalyst. The process includes moisture curing the second composition, and forming a crosslinked ethylene-Si polymer.

The present disclosure provides a composition. In an embodiment, the composition includes a functionalized ethylene-Si polymer having a Structure (1)

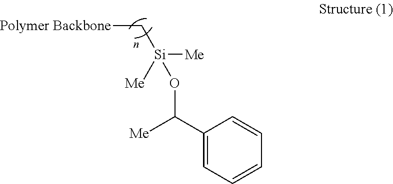

wherein n is an integer from 4 to 6.

### BRIEF DESCRIPTION OF THE DRAWINGS

FIG. 1 is a graph showing the DMA of IE2 (1 MI ethylene-SiH polymer, 3.5 wt % HDMS, 1 eqv. acetophenone vs. SiH, 500 ppm FAB, 500 ppm DBSA) cured at 20° C., 50% RH. Percentage next to the curve indicates the gel content.

FIG. 2 is a graph showing the FTIR of ethylene-SiH polymer and IE2 (1 MI ethylene-SiH polymer, 3.5 wt % HDMS, 1 eqv. acetophenone vs. SiH, 500 ppm FAB, 500 ppm DBSA) before and after 5-day moisture cure at 20° C., 50% RH.

FIG. 3 is a graph showing the DMA of IE3 (1 MI ethylene-SiH polymer, 3.5 wt % HDMS, 1 eqv. acetophenone vs. SiH, 500 ppm FAB, 500 ppm DBSA) cured at 25° C., 16-25% RH.

FIG. 4 is a graph showing the DMA of IE4 (1 MI ethylene-SiH polymer, 3.5 wt % HDMS, 1 eqv. acetophenone vs. SiH, 500 ppm FAB, 500 ppm DBSA) cured at 50° C., 6-9% RH.

FIG. 5 is a graph showing the DMA of IE5 (1 MI ethylene-SiH polymer, 3.5 wt % HDMS, 1 eqv. acetophenone vs. SiH, 500 ppm FAB, 500 ppm DBSA) cured at 21° C., 1% RH. Percentage next to the curve indicates the gel content.

FIG. 6 is a graph showing the DMA of IE6 (1 MI ethylene-SiH polymer, 3.5 wt % HDMS, 1 eqv. acetophenone vs. SiH, 500 ppm FAB, 500 ppm DBSA) cured in a 50° C. water bath. Percentage next to the curve indicates the gel content.

FIG. 7 is a graph showing the DMA of IE7 (1 MI ethylene-SiH polymer, 3.5 wt % HDMS, 1 eqv. acetophenone vs. SiH, 500 ppm FAB, 100 ppm DBSA) cured at 20° C., 50% RH. Percentage next to the curve indicates the gel content.

FIG. 8 is a graph showing the DMA of IE8 (1 MI ethylene-SiH polymer, 3.5 wt % HDMS, 1 eqv. acetophenone vs. SiH, 500 ppm FAB, 2000 ppm DBSA) cured at 20° C., 50% RH. Percentage next to the curve indicates the gel contents.

FIG. 9 is a graph showing the DMA of IE9 (1 MI ethylene-SiH polymer, 3.5 wt % HDMS, 1 eqv. acetophenone vs. SiH, 50 ppm FAB, 500 ppm DBSA) cured at 20° C., 50% RH. Percentage next to the curve indicates the gel content.

FIG. 10 is a graph showing the DMA of IE10 (1 MI ethylene-SiH polymer, 3.5 wt % HDMS, 0.5 eqv. acetophenone vs. SiH, 500 ppm FAB, 500 ppm DBSA) cured at 20° C., 50% RH. Percentage next to the curve indicates the gel content.

FIG. 11 is a graph showing the DMA of IE11 (1 MI ethylene-SiH polymer, 3.5 wt % HDMS, 1.5 eqv. acetophenone vs. SiH, 500 ppm FAB, 500 ppm DBSA) cured at 20° C., 50% RH. Percentage next to the curve indicates the gel content.

FIG. 12 is a graph showing the DMA of IE12 (1 MI ethylene-SiH polymer, 1.5 wt % HDMS, 1 eqv. acetophenone vs. SiH, 500 ppm FAB, 500 ppm DBSA) cured at 20° C., 50% RH. Percentage next to the curve indicates the gel content.

FIG. 13 is a graph showing the DMA of IE13 (18 MI ethylene-SiH polymer, 3 wt % HDMS, 1 eqv. acetophenone vs. SiH, 500 ppm FAB, 500 ppm DBSA) cured at 20° C., 50% RH. The 1 week and 2 weeks data were overlapped. Percentage next to the curve indicates the gel content.

FIG. 14 is a graph showing the DMA of CS1 (1 MI ethylene-SiH polymer, 2.5 wt % ODMS, 1 eqv. acetophenone, 500 ppm FAB) cured at 25° C., 16-25% RH.

FIG. 15 is a graph showing the DMA of CS2 (1 MI ethylene-SiH polymer, 3.5 wt % HDMS, 2000 ppm DBSA) cured at 20° C., 50% RH. Percentage next to the curve indicates the gel content.

FIG. 16 is a graph showing the DMA of CS3 (1 MI POE, 1.8 wt % DCP) at 180° C. for 10 minutes.

### DEFINITIONS

Any reference to the Periodic Table of Elements is that as published by CRC Press, Inc., 1990-1991. Reference to a group of elements in this table is by the new notation for numbering groups.

For purposes of United States patent practice, the contents of any referenced patent, patent application or publication are incorporated by reference in their entirety (or its equivalent US version is so incorporated by reference) especially with respect to the disclosure of definitions (to the extent not inconsistent with any definitions specifically provided in this disclosure) and general knowledge in the art.

The numerical ranges disclosed herein include all values from, and including, the lower and upper value. For ranges containing explicit values (e.g., 1 or 2, or 3 to 5, or 6, or 7), any subrange between any two explicit values is included (e.g., the range 1-7 above includes subranges of 1 to 2; 2 to 6; 5 to 7; 3 to 7; 5 to 6; etc.).

Unless stated to the contrary, implicit from the context, or customary in the art, all parts and percents are based on weight, and all test methods are current as of the filing date of this disclosure.

The term “composition” refers to a mixture of materials which comprise the composition, as well as reaction products and decomposition products formed from the materials of the composition.

The terms “comprising,” “including,” “having” and their derivatives, are not intended to exclude the presence of any additional component, step or procedure, whether or not the same is specifically disclosed. In order to avoid any doubt, all compositions claimed through use of the term “comprising” may include any additional additive, adjuvant, or compound, whether polymeric or otherwise, unless stated to the contrary. In contrast, the term “consisting essentially of” excludes from the scope of any succeeding recitation any other component, step, or procedure, excepting those that are not essential to operability. The term “consisting of” excludes any component, step, or procedure not specifically delineated or listed. The term “or,” unless stated otherwise, refers to the listed members individually as well as in any combination. Use of the singular includes use of the plural and vice versa.

A “Dalton” is the unit for the molecular weight of a polymer and is equivalent to an atomic mass unit, with abbreviation “Da,” or “kDa” (kilo Dalton).

An “ethylene-based polymer” or “ethylene polymer” is a polymer that contains a majority amount of polymerized ethylene based on the weight of the polymer and, optionally, may comprise at least one comonomer. Ethylene-based polymers typically comprise at least 50 mole percent (mol %) units derived from ethylene (based on the total amount of polymerizable monomers).

A “hydrocarbon” (or, “hydrocarbyl” a “hydrocarbyl group”) is a compound containing only hydrogen atoms and carbon atoms.

The terms “heterohydrocarbon,” (“heterohydrocarbyl,” or heterohydrocarbyl group”) and similar terms, as used herein, refer to a respective hydrocarbon, in which at least one carbon atom is substituted with a heteroatom group (for example, Si, O, N or P).

The terms “substituted hydrocarbon,” (or “substituted hydrocarbyl,” or ““substituted hydrocarbyl group”) refers to a hydrocarbon in which one or more hydrogen atoms is/are independently substituted with a heteroatom group. The terms “substituted heterohydrocarbon,” (“substituted heterohydrocarbyl,” or “substituted heterohydrocarbyl group”) and similar terms, as used herein, refer to a respective heterohydrocarbon in which one or more hydrogen atoms is/are independently substituted with a heteroatom group.

An “interpolymer” is a polymer prepared by the polymerization of at least two different types of monomers. The generic term interpolymer thus includes copolymers (employed to refer to polymers prepared from two different types of monomers), and polymers prepared from more than two different types of monomers.

An “olefin-based polymer” or “polyolefin” is a polymer that contains a majority mole percent polymerized olefin monomer (based on total amount of polymerizable monomers), and optionally, may contain at least one comonomer. Nonlimiting examples of olefin-based polymer include ethylene-based polymer and propylene-based polymer. Representative polyolefins include polyethylene, polypropylene, polybutene, polyisoprene and their various interpolymers.

A “polymer” is a polymeric compound prepared by polymerizing monomers, whether of the same or a different type. The generic term polymer thus embraces the term “homopolymer” (employed to refer to polymers prepared from only one type of monomer, with the understanding that trace amounts of impurities can be incorporated into the polymer structure), and the term “interpolymer,” as defined hereinafter. Trace amounts of impurities, for example, catalyst residues, may be incorporated into and/or within the polymer. It also embraces all forms of copolymer, e.g., random, block, etc. The terms “ethylene/α-olefin polymer” and “propylene/α-olefin polymer” are indicative of copolymer as described above prepared from polymerizing ethylene or propylene respectively and one or more additional, polymerizable α-olefin monomer. It is noted that although a polymer is often referred to as being “made of” one or more specified monomers, “based on” a specified monomer or monomer type, “containing” a specified monomer content, or the like, in this context the term “monomer” is understood to be referring to the polymerized remnant of the specified monomer and not to the unpolymerized species. In general, polymers herein are referred to as being based on “units” that are the polymerized form of a corresponding monomer.

A “propylene-based polymer” is a polymer that contains a majority amount of polymerized propylene based on the weight of the polymer and, optionally, may comprise at least one comonomer. Propylene-based polymers typically comprise at least 50 mole percent (mol %) units derived from propylene (based on the total amount of polymerizable monomers).

The terms “thermally treating,” “thermal treatment,” and similar terms, as used herein, refer to the application of heat to a composition. Heat may be applied by conduction (for example, a heating coil), by convection (for example, heat transfer through a fluid, such as water or air), and/or by radiation (for example, heat transfer using electromagnetic waves). Preferably heat is applied by conduction or convection. Note, the temperature at which the thermal treatment takes place, refers to the internal temperature of the oven or other device used to cure (or crosslink) the interpolymer.

### Test Methods

Density is measured in accordance with ASTM D792, Method B (g/cc or g/cm³).

Differential Scanning Calorimetry (DSC). Differential Scanning Calorimetry (DSC) is used to measure Tm, Tc, Tg and crystallinity in ethylene-based polymer samples. About 5 to 8 mg of sample was weighed and placed in a DSC pan. The lid was crimped on the pan to ensure a closed atmosphere. Unless otherwise stated, the sample pan was placed in a DSC cell, and then heated, at a rate of 10° C./min, to a temperature of 200° C. The sample was kept at this temperature for three minutes. Then the sample was cooled at a rate of 10° C./min to −90° C., and kept isothermally at that temperature for three minutes. The sample was next heated at a rate of 10° C./min, until complete melting (second heat). Unless otherwise stated, melting point (Tm) and the glass transition temperature (Tg) of each polymer were determined from the second heat curve. The peak heat flow temperature for the Tm was recorded.

Dynamic Mechanical Analysis. Oscillatory rheological tests were performed on a strain-controlled rotational rheometer (ARES or ARES-G2, TA Instruments) using a rectangular torsion fixture geometry. An oscillatory small amplitude within the linear viscoelastic regime was applied at an angular frequency of 1 rad/s as the rectangular sample (^{˜}2 mm thick) was heated at a ramp rate of 2° C./min.

FTIR-ATR. Infrared spectra were collected on a Perkin Elmer Frontier Fourier-transform infrared spectrometer (FT-IR) with attenuated total reflection (ATR) accessory (single bounce diamond/ZnSe). Samples were cut with scissors to reveal a clean interior surface, then placed into the accessory and held at a force where the peak absorbance is approximately 0.4 and 4-16 scans were collected depending on spectrum quality. Spectra was collected in at least triplicate to ensure representative sampling of the entire sample.

Gel content analysis was performed using a Soxhlet extraction setup following a similar procedure to that described in ASTM D2765. A known mass of the sample (m₀) was placed in a pre-weighed glass fiber thimble (mₜ) and extracted by boiling xylenes (b.p. ^{˜}136° C.) for 15 hours under N₂. Afterwards, the thimble together with any sample residues was dried at 50° C. under vacuum. The final mass of the thimble and the residual sample was measured (m₁), and the gel content was calculated using the equation below.

$$Gel content \% = \frac{{m}_{1} - ( {m}_{0} + {m}_{t} )}{{m}_{0}} \times 100 \%$$

Gel Permeation Chromatography. For polymers 2-5 in the Examples section, the chromatographic system consisted of a PolymerChar GPC-IR (Valencia, Spain) high temperature GPC chromatograph, equipped with an internal IR5 infra-red detector (IR5). The autosampler oven compartment was set at 1602 Celsius, and the column compartment was set at 1500 Celsius. The columns were four AGILENT “Mixed A” 30 cm, 20-micron linear mixed-bed columns. The chromatographic solvent was 1,2,4-trichloro-benzene, which contained 200 ppm of butylated hydroxytoluene (BHT). The solvent source was nitrogen sparged. The injection volume used was 200 microliters, and the flow rate was 1.0 milliliters/minute.

Calibration of the GPC column set was performed with 21 narrow molecular weight distribution polystyrene standards, with molecular weights ranging from 580 to 8,400,000, and which were arranged in six “cocktail” mixtures, with at least a decade of separation between individual molecular weights. The standards were purchased from Agilent Technologies. The polystyrene standards were prepared at “0.025 grams in 50 milliliters” of solvent, for molecular weights equal to, or greater than, 1,000,000, and at “0.05 grams in 50 milliliters” of solvent, for molecular weights less than 1,000,000. The polystyrene standards were dissolved at 80 degrees Celsius, with gentle agitation, for 30 minutes. The polystyrene standard peak molecular weights were converted to polyethylene molecular weights using Equation 1 (EQ1) (as described in Williams and Ward, J. Polym. Sci., Polym. Let., 6, 621 (1968)):

$${M}_{polyethylene} = A \times {( {M}_{polystyrene} )}^{B} , \qquad ( EQ 1 )$$

where M is the molecular weight, A has a value of 0.4315 and B is equal to 1.0.

A fifth order polynomial was used to fit the respective polyethylene-equivalent calibration points. A small adjustment to A (from approximately 0.375 to 0.445) was made to correct for column resolution and band-broadening effects, such that linear homopolymer polyethylene standard is obtained at 120,000 Mw. The total plate count of the GPC column set was performed with decane (prepared at “0.04 g in 50 milliliters” of TCB, and dissolved for 20 minutes with gentle agitation.) The plate count (Equation 2, EQ2) and symmetry (Equation 3, EQ3) were measured on a 200 microliter injection according to the following equations:

$$Plate Count = 5.54 * {( \frac{( R {V}_{Peak Max}}{Peak Width at \frac{1}{2} height} )}^{2} , \qquad ( EQ2 )$$

where RV is the retention volume in milliliters, the peak width is in milliliters, the peak max is the maximum height of the peak, and %2 height is %2 height of the peak maximum; and

$$Symmetry = \frac{( Rear Peak {RV}_{one tenth height} - R {V}_{Peak max} )}{( {RV}_{Peak max} - Front Peak {RV}_{one tenth height} )} \qquad ( EQ3 )$$

where RV is the retention volume in milliliters, and the peak width is in milliliters, Peak max is the maximum position of the peak, one tenth height is 1/10 height of the peak maximum, and where rear peak refers to the peak tail at later retention volumes than the peak max, and where front peak refers to the peak front at earlier retention volumes than the peak max. The plate count for the chromatographic system should be greater than 18,000, and symmetry should be between 0.98 and 1.22.

Samples were prepared in a semi-automatic manner with the PolymerChar “Instrument Control” Software, wherein the samples were weight-targeted at 2 mg/ml, and the solvent (contained 200 ppm BHT) was added to a pre nitrogen-sparged, septa-capped vial, via the PolymerChar high temperature autosampler. The samples were dissolved for two hours at 1602 Celsius under “low speed” shaking.

The calculations of Mn_{(GPC)}, Mw_{(GPC)}, and Mz_{(GPC)} were based on GPC results using the internal IR5 detector (measurement channel) of the PolymerChar GPC-IR chromatograph according to Equations 4-6, using PolymerChar GPCOne™ software, the baseline-subtracted IR chromatogram at each equally-spaced data collection point (i), and the polyethylene equivalent molecular weight obtained from the narrow standard calibration curve for the point (i) from Equation 1. Equations 4-6 (EQ4-EQ6) are as follows:

$${Mn}_{( GPC )} = \frac{{\sum }^{i} {IR}_{i}}{{\sum }^{i} ( {IR}_{i} / {{M}_{polyethylene}}_{i} )} , \qquad ( EQ 4 )$$

$${Mw}_{( GPC )} = \frac{{\sum }^{i} ( {IR}_{i} * {M}_{{polyethylene}_{i}} )}{{\sum }^{i} {IR}_{i}} , and \qquad ( EQ 5 )$$

$${Mz}_{( GPC )} = \frac{{\sum }^{i} ( {IR}_{i} * {M}_{{polyethylene}_{i}^{2}} )}{{\sum }^{i} ( {IR}_{i} * {M}_{{polyethylene}_{i}} )} . \qquad ( EQ 6 )$$

In order to monitor the deviations over time, a flowrate marker (decane) was introduced into each sample, via a micropump controlled with the PolymerChar GPC-IR system. This flowrate marker (FM) was used to linearly correct the pump flowrate (Flowrate(nominal)) for each sample, by RV alignment of the respective decane peak within the sample (RV(FM Sample)), to that of the decane peak within the narrow standards calibration (RV(FM Calibrated)). Any changes in the time of the decane marker peak were then assumed to be related to a linear-shift in flowrate (Flowrate(effective)) for the entire run. To facilitate the highest accuracy of a RV measurement of the flow marker peak, a least-squares fitting routine was used to fit the peak of the flow marker concentration chromatogram to a quadratic equation. The first derivative of the quadratic equation was then used to solve for the true peak position. After calibrating the system, based on a flow marker peak, the effective flowrate (with respect to the narrow standards calibration) was calculated as Equation 7: Flowrate(effective)=Flowrate(nominal)*(RV(FM Calibrated)/RV(FM Sample)) (EQ7). Processing of the flow marker peak was done via the PolymerChar GPCOne™ Software. Acceptable flowrate correction is such that the effective flowrate should be within +/−0.7% of the nominal flowrate.

For polymer 1 in the Examples section, the chromatographic system consisted of a PolymerChar GPC-IR (Valencia, Spain) high temperature GPC chromatograph, equipped with an internal IR5 infra-red detector (IR5). The autosampler oven compartment was set at 1602 Celsius, and the column compartment was set at 1502 Celsius. The columns were one Agilent PLgel MIXED 7.5×50 mm, 20 μm linear mixed-bed guard column followed by four Agilent PLgel MIXED-A 7.5×300 mm, 20-micron linear mixed-bed columns. The chromatographic solvent was 1,2,4-trichlorobenzene (TCB), which contained 200 ppm of butylated hydroxytoluene (BHT). The solvent source was nitrogen sparged. The injection volume used was 200 microliters, and the flow rate was 1.0 milliliters/minute.

Calibration of the GPC column set was performed using Agilent EasiCal Polystyrene standards (EasiCal PS-1 and EasiCal PS-2). Each EasiCal system consisted of two different spatulas supporting a mixture of 5 polymer standards (approximately 5 mg) to obtain 20 molecular weights points ranging from approximately 580 to 6,570,000 g/mole. Individual spatulas were added to septa-capped vials, sealed and loaded into the PolymerChar autosampler. PolymerChar Instrument Control Software was utilized to add 8 mL of solvent to each vial and the standards were dissolved for 15 minutes at 1602 Celsius under high-speed shaking prior to injection to the chromatography system. The polystyrene standard peak molecular weights were converted to polyethylene molecular weights using Equation 7 (as described in Williams and Ward, J. Polym. Sci., Polym. Let., 6, 621 (1968)):

$${M}_{polyethylene} = A \times {( {M}_{polystyrene} )}^{B} , \qquad ( EQ 1 )$$

A has a value of 0.4315 and B is equal to 1.0.

A third order polynomial was used to fit the respective polyethylene-equivalent calibration points. A small adjustment to A (from approximately 0.375 to 0.445) was made to correct for column resolution and band-broadening effects, such that linear low-density polyethylene standard is obtained at 120,000 Mw. The total plate count of the GPC column set was performed with decane (3% v/v in TCB introduced via micropump.) The plate count (Equation 2) and symmetry (Equation 3) were measured on a 200 microliter injection according to the following equations:

$$Plate Count = 5.54 * {( \frac{( R {V}_{Peak Max}}{Peak Width at \frac{1}{2} height} )}^{2} , \qquad ( EQ2 )$$

where RV is the retention volume in milliliters, the peak width is in milliliters, the peak max is the maximum height of the peak, and ½ height is ½ height of the peak maximum; and

$$Symmetry = \frac{( Rear Peak {RV}_{one tenth height} - R {V}_{Peak max} )}{( {RV}_{Peak max} - Front Peak {RV}_{one tenth height} )} \qquad ( EQ3 )$$

where RV is the retention volume in milliliters, and the peak width is in milliliters, Peak max is the maximum position of the peak, one tenth height is 1/10 height of the peak maximum, and where rear peak refers to the peak tail at later retention volumes than the peak max, and where front peak refers to the peak front at earlier retention volumes than the peak max. The plate count for the chromatographic system should be greater than 18,000, and symmetry should be between 0.98 and 1.22.

Samples were prepared in a semi-automatic manner with the PolymerChar “Instrument Control” Software, wherein the samples were weight-targeted at 2 mg/ml, and the solvent (contained 200 ppm BHT) was added to a septa-capped vial, via the PolymerChar high temperature autosampler. The samples were dissolved for two hours at 160° Celsius under “high speed” shaking.

The calculations of Mn_{(GPC)}, Mw_{(GPC)}, and Mz_{(GPC)} were based on GPC results using the internal IR5 detector (measurement channel) of the PolymerChar GPC-IR chromatograph according to Equations 4-6, using PolymerChar GPCOne™ software, the baseline-subtracted IR chromatogram at each equally-spaced data collection point (i), and the polyethylene equivalent molecular weight obtained from the narrow standard calibration curve for the point (i) from Equation 1. Equations 4-6 are as follows:

$${Mn}_{( GPC )} = \frac{{\sum }^{i} {IR}_{i}}{{\sum }^{i} ( {IR}_{i} / {{M}_{polyethylene}}_{i} )} , \qquad ( EQ 4 )$$

$${Mw}_{( GPC )} = \frac{{\sum }^{i} ( {IR}_{i} * {M}_{{polyethylene}_{i}} )}{{\sum }^{i} {IR}_{i}} , and \qquad ( EQ 5 )$$

$${Mz}_{( GPC )} = \frac{{\sum }^{i} ( {IR}_{i} * {M}_{{polyethylene}_{i}^{2}} )}{{\sum }^{i} ( {IR}_{i} * {M}_{{polyethylene}_{i}} )} . \qquad ( EQ 6 )$$

In order to monitor the deviations over time, a flowrate marker (decane) was introduced into each sample, via a micropump controlled with the PolymerChar GPC-IR system. This flowrate marker (FM) was used to linearly correct the pump flowrate (Flowrate(nominal)) for each sample, by RV alignment of the respective decane peak within the sample (RV(FM Sample)), to that of the decane peak within the narrow standards calibration (RV(FM Calibrated)). Any changes in the time of the decane marker peak were then assumed to be related to a linear-shift in flowrate (Flowrate(effective)) for the entire run. To facilitate the highest accuracy of a RV measurement of the flow marker peak, a least-squares fitting routine was used to fit the peak of the flow marker concentration chromatogram to a quadratic equation. The first derivative of the quadratic equation was then used to solve for the true peak position. After calibrating the system, based on a flow marker peak, the effective flowrate (with respect to the narrow standards calibration) was calculated as Equation 7: Flowrate(effective)=Flowrate(nominal)*(RV(FM Calibrated)/RV(FM Sample)) (EQ7). Processing of the flow marker peak was done via the PolymerChar GPCOne™ Software. Acceptable flowrate correction is such that the effective flowrate should be within +/−0.7% of the nominal flowrate.

Melt Index. The melt index (or “12”) of an ethylene-based polymer is measured in accordance with ASTM D-1238, condition 190° C./2.16 kg (melt index 110 at 190° C./10.0 kg). The I₁₀/I₂ was calculated from the ratio of I₁₀ to the I₂. The melt flow rate MFR of a propylene-based polymer is measured in accordance with ASTM D-1238, condition 230° C./2.16 kg.

Nuclear Magnetic Resonance (NMR) Characterization of Terpolymers. For ¹³C NMR experiments, samples were dissolved, in 10 mm NMR tubes, in tetrachloroethane-d₂ (with or without 0.025 M Cr(acac)₃). The concentration was approximately 300 mg/2.8 mL. Each tube was then heated in a heating block set at 110° C. The sample tube was repeatedly vortexed and heated to achieve a homogeneous flowing fluid. The ¹³C NMR spectrum was taken on a BRUKER AVANCE 600 MHz spectrometer, equipped with a 10 mm C/H DUAL cryoprobe. The following acquisition parameters were used: 60 seconds relaxation delay, 90 degree pulse of 12.0 μs, 256 scans. The spectrum was centered at 100 ppm, with a spectral width of 250 ppm. All measurements were taken without sample spinning at 110° C. The ¹³C NMR spectrum was referenced to “74.5 ppm” for the resonance peak of the solvent. For a sample with Cr, the data was taken with a “7 seconds relaxation delay” and 1024 scans.

For 1H NMR experiments, each sample was dissolved, in 5 mm NMR tubes, in tetrachloroethane-d₂. The concentration was approximately 100 mg/1.8 mL. Each tube was then heated in a heating block set at 110° C. The sample tube was repeatedly vortexed and heated to achieve a homogeneous flowing fluid. The ¹H NMR spectrum was taken on a VARIAN 500 MHz spectrometer. A standard single pulse 1H NMR experiment was performed. The following acquisition parameters were used: 60 seconds relaxation delay, 16-32 scans. All measurements were taken without sample spinning at 110° C. The ¹H NMR spectrum was referenced to “5.99 ppm” for the resonance peak of the solvent (residual protonated tetrachloroethane). ¹H NMR was used to determine the polymerized SiH monomer content (wt %), in the ethylene-SiH polymer. The “wt % SiH monomer” was calculated based on the integration of SiMe proton resonances, versus the integration of CH₂ protons associated with ethylene units and CH₃ protons associated with octene units. The “wt % octene (or other alpha-olefin)” can be similarly determined by reference to the CH₃ protons associated with octene units (or other alpha-olefin).

SiH Conversion. SiH conversion is determined with FTIR-ATR. See FTIR-ATR test method. The percent (%) SiH conversion is described under the FTIR-ATR test method.

### DETAILED DESCRIPTION

The present disclosure provides a process. In an embodiment, the process includes first melt blending, at a temperature from 80° C. to 200° C., a first composition composed of (i) an ethylene-SiH polymer, (ii) a coagent that is a monoketone, (iii) a triarylborane, and forming a functionalized ethylene-Si polymer. The process further includes second melt blending, at a temperature from 80° C. to 200° C., a second composition composed (iv) the functionalized ethylene-SiH polymer and (v) a cure catalyst, and subsequently curing the second composition and forming a crosslinked ethylene-Si polymer.

The process includes first melt blending, at a temperature from 80° C. to 200° C., a first composition composed of (i) an ethylene-SiH polymer, (ii) a coagent that is a monoketone, and (iii) a triarylborane. The ethylene-SiH polymer is composed of (1) ethylene monomer, (2) from 0.1 wt % to 3.9 wt % of a SiH comonomer, and (3) optional C₃-C₁₂ α-olefin or C₄-C₈ α-olefin termonomer. An “SiH comonomer,” (interchangeably referred to as “SiH”) as used herein, is a silane monomer of Formula 1:

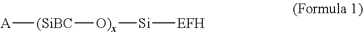

wherein A is an alkenyl group,
B is a hydrocarbyl group or hydrogen,
C is a hydrocarbyl group or hydrogen, and
wherein B and C may be the same or different, and further B is a hydrocarbyl group, C is a hydrocarbyl group, and further B and C are the same;
H is hydrogen, and x≥0;
E is a hydrocarbyl group or hydrogen,
F is a hydrocarbyl group or hydrogen, E and F may be the same or different, and when E is a hydrocarbyl group F is a hydrocarbyl group, E and F may be the same hydrocarbyl group. Nonlimiting samples of suitable SiH comonomer of Formula 1 include compounds s1) (allyldimethylsilane), s2) (propenyldimethylsilane), s3) (butenyldimethylsilane), s4) (hexenyldimethylsilane), s5) (octenyldimethylsilane), s6), (decenyldimethylsilane), s7) norbornylethyldimethylsilane, s8) octahydrodimethanonaphthalenylethyldimethysilane, s9) vinyltetramethyldisiloxane, s10) allyltetramethyldisiloxane, s11) butenyltetramethyldisiloxane, s12), hexenyltetramethyldisiloxane, s13) octenyltetramethyldisiloxane, s14) decenyltetramethyldisiloxane, s15) norbornylethyltetramethyldisiloxane, s16) octahydrodimethanonaphthalenylethyltetramethyldisiloxane below:

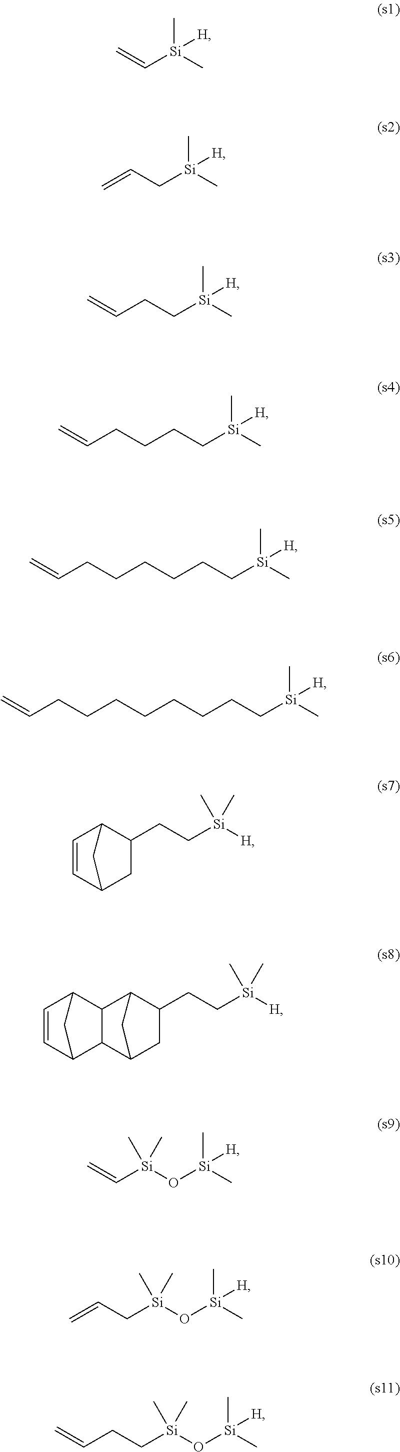

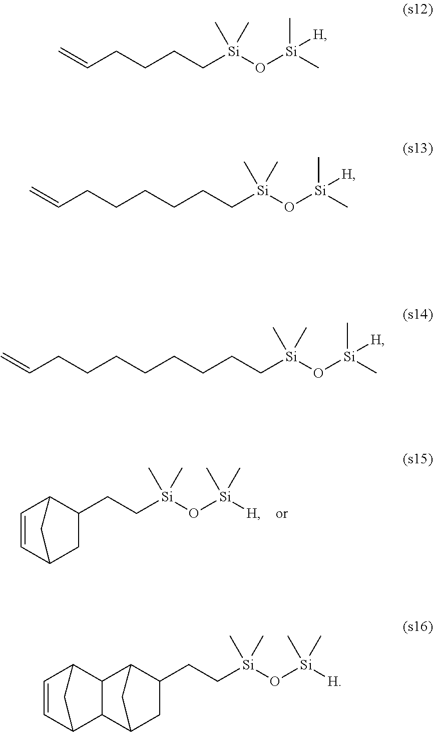

In an embodiment, the SiH comonomer is selected from allyldimethylsilane, hexenyldimethylsilane, octenyldimethylsilane, and hexenyltetramethyldisiloxane.

In an embodiment, the ethylene-SiH polymer is an ethylene/α-olefin/SiH terpolymer. The α-olefin in the ethylene/α-olefin/SiH comonomer terpolymer can be a C₃-C₁₂ α-olefin or a C₄-C₈ α-olefin. Nonlimiting examples of suitable α-olefin include propylene, butene, hexene, octene, and ethylidene norbornene for respective ethylene/propylene SiH terpolymer, ethylene/butene/SiH terpolymer, ethylene/hexene/SiH terpolymer, ethylene/octene/SiH terpolymer and ethylene/ethylidene norbornene/SiH terpolymer.

In an embodiment, the ethylene/α-olefin/SiH terpolymer is an ethylene/octene/SiH terpolymer. Nonlimiting examples of suitable ethylene/octene/SiH terpolymer include ethylene/octene/hexenyldimethylsilane (HDMS) terpolymer, ethylene/octene/octenyldimethylsilane (ODMS) terpolymer, and combinations thereof.

In an embodiment, the ethylene/α-olefin/SiH terpolymer is an ethylene/octene/SiH terpolymer. The ethylene/octene/SiH terpolymer includes from 32 wt % to 35 wt % octene, and from 0.5 w % to 5 wt %, or from 1.0 wt % to 3.5 wt % SiH comonomer and has a density from 0.87 g/cc to 0.89 g/cc, and an MI from 1 g/10 min to 18 g/10 min, or from 2 g/10 min to 12 g/10 min. Nonlimiting examples of suitable ethylene/octene/SiH terpolymer include ethylene/octene/allyldimethylsilane (ADMS) terpolymer, ethylene/octene/hexenyldimethylsilane (HDMS) terpolymer, ethylene/octene/octenyldimethylsilane (ODMS) terpolymer.

In an embodiment, the ethylene-SiH polymer is selected from ethylene/octene/HDMS terpolymer and ethylene/octene/ODMS terpolymer.

In an embodiment, the ethylene-SiH polymer is ethylene/octene/HDMS terpolymer.

In an embodiment, the ethylene-SiH polymer is ethylene/octene/ODMS terpolymer.

The first composition includes (ii) a coagent that is a monoketone (interchangeably referred to as “monoketone coagent”). A “monoketone coagent,” as used herein, is a hydrocarbon containing a single carbonyl group. Nonlimiting examples of suitable monoketone coagent include acetophenone, benzophenone, acetone, methyl ethyl ketone, and butanone. In an embodiment, the monoketone coagent is acetophenone.

The first composition includes (iii) a triaryl borane. The three aryl groups may be the same or may be different. Each of the three aryl groups independently may include one, or two, or three, or four, or five substituents selected from hydrogen, chlorine, fluorine, trifluoromethyl groups, and combinations thereof. The triarylborane is a Lewis acid catalyst and promotes the hydrosilylation reaction between the SiH monomer of the ethylene-SiH polymer and the carbonyl groups of the 1,3-dibenzoylpropane. Nonlimiting examples of suitable triarylborane include tris(pentafluorophenyl)borane (FAB), tris(3,5-bis(trifluoromethyl)phenyl)borane; bis(3,5-bis(trifluoromethyl)phenyl)(2,4,6-trifluorophenyl)borane; bis(3,5-bis(trifluoromethyl)phenyl)(2,5-bis(trifluoromethyl)phenyl)borane; bis(3,5-bis(trifluoromethyl)phenyl)(4-trifluoromethylphenyl)borane, bis(3,5-bis(trifluoromethyl)phenyl)(2,6-difluorophenyl)borane, tris(2,5-bis(trifluoromethyl)phenyl)borane, and combinations thereof.

The (i) ethylene-SiH polymer, (ii) the monoketone coagent, and (iii) the triarylborane, are melt blended (or first melt blended), or otherwise mixed, at a temperature and for a length of time sufficient to fully homogenize the mixture. The first melt blending is conducted by way of batch mixing or continuous mixing at a temperature from 80° C. to 200° C., or from 90° C. to 150° C., or from 100° C. to 120° C. for 1 minute to 20 minutes, or from 2 minutes to 15 minutes, or from 3 minutes to 10 minutes. The first melt blending, in the presence of the triarylborane catalyst, initiates a hydrosilylation reaction between the Si—H moiety of the ethylene-SiH polymer and the carbonyl group of the monoketone coagent, thereby grafting the monoketone coagent to the ethylene-SiH polymer to form a functionalized ethylene-Si polymer. A “functionalized ethylene-Si polymer,” as used herein, is the reaction product between the ethylene-SiH polymer and the monoketone coagent whereby the monoketone coagent is grafted to, or otherwise is covalently bonded to, the ethylene-SiH polymer at the silicon atom of the SiH moiety by way of a Si—O—C— bond.

The functionalized ethylene-Si polymer has little, or no, crosslinking and has a gel content from 0% to less than 2.5%. In other words, the functionalized ethylene-Si polymer has a shear storage modulus (G′) value less than 1×10⁶ Pa at 100° C.

In an embodiment, the crosslinked ethylene-Si polymer is the reaction product between the ethylene-SiH polymer and the monoketone coagent that is acetophenone whereby acetophenone is grafted to the ethylene-SiH polymer to form Structure (1) below:

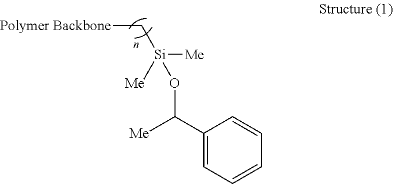

wherein
Me is a methyl group (CH₃), and
n is an integer from 4 to 6 (or 4, or 5, or 6).

The process includes second melt blending, at a temperature from 80° C. to 200° C., a second composition composed of (iv) the functionalized ethylene-Si polymer and (v) a cure catalyst. A “cure catalyst,” as used herein, is a compound that accelerates the reaction, in the presence of moisture, between pendant silane moieties, for example, —Si(R¹)(R²)H, of two or more olefin/silane interpolymer chains. Examples of cure catalysts include metal alkoxides, metal carboxylates, metal sulfonates, aryl sulfonic acids and tris-aryl boranes. A metal alkoxide is typically represented by M(OR)ₙ, where M is a metal, and R is an alkyl group, and n≥1. In an embodiment, M is titanium (Ti) or tin (Sn).

A metal carboxylate is typically represented by M[O—C(O)—R]ₘ, where M is a metal, R is an alkyl and m≥1, or by (R′)ₙM[O—C(O)—R]ₘ, where R′ and R each is independently an alkyl, M is a metal, n≥1 and m 1. In an embodiment, M is Ti or Sn. In a further embodiment, M is Sn.

A metal sulfonate is typically represented M[OS(O)₂R]ₙ, where M is a metal, R is a substituted or unsubstituted alkyl group and n 1. For example, one or more hydrogen atoms on the alkyl group may be substituted with halo groups, such as F. In an embodiment, M is bismuth.

An aryl sulfonic acid includes at least one aryl group and at least one sulfonic acid group. An example of an aryl sulfonic acid is represented by Ar—S(O)₂—OH, where Ar is an aryl group containing one or more alkyl groups. The aryl group may be bicyclic, tricyclic, etc. Examples of aryl sulfonic acids are described in International Publication WO2002/12355 incorporated by reference herein.

Nonlimiting examples of suitable cure catalyst include dibutyltindilaurate, tetrabutyl titanium oxide, dodecylbenezene sulfonic acid (DBSA), bismuth trifluorosulfonate, and combinations thereof.

In an embodiment, the cure catalyst is dodecylbenezene sulfonic acid (DBSA).

The components of the second composition (iv) the functionalized ethylene-Si polymer and (v) the cure catalyst are melt blended (or second melt blended), or otherwise mixed, at a temperature and for a length of time sufficient to fully homogenize the mixture. The second melt blending is conducted by way of batch mixing or continuous mixing at a temperature from 80° C. to 200° C., or from 90° C. to 150° C., or from 100° C. to 120° C. for 1 minute to 20 minutes, or from 2 minutes to 15 minutes, or from 3 minutes to 10 minutes.

In an embodiment, the process includes forming, or otherwise shaping, the second composition into an article (prior to the moisture cure step). Nonlimiting shaping procedures include pressing, rolling, molding, extruding, compressing, and combinations thereof to form nonlimiting articles such as a film, a sheet, a plaque, a pellet, an annular structure, and combinations thereof.

Upon completion of the second melt blending, the second composition is moisture cured to form a crosslinked ethylene-Si polymer. “Moisture cure,” as used herein, refers to the curing, or crosslinking of the second composition (after the second melt blending) upon exposure to water. Water can be in the form of atmospheric moisture (moisture present in air) or water in the form of a water bath. The speed and degree of moisture cure or crosslinking is a function of the amount of silane functionality in the second composition, the nature of the exposure to water (e.g., immersion in a water bath, relative humidity of air, etc.), the duration of the exposure, and temperature. During moisture cure, the Si—C—C bonds in the functionalized ethylene-SiH polymer hydrolyze in the presence of moisture (water, air humidity, steam) and the cure catalyst to form silanol groups. The silanol groups condense with each other in the presence of the cure catalyst to form Si—O—Si linkages, the Si—O—Si linkages bonding, or otherwise crosslinking individual chains of the ethylene-SiH polymer to each other. A “crosslinked ethylene-Si polymer,” as used herein, is the moisture cure reaction product whereby Si—O—Si linkages crosslink, or otherwise bond, individual polymer chains of the functionalized ethylene-SiH polymer together forming a network structure of bonded polymer chains.

In an embodiment, moisture cure includes exposing the second composition to air having a relative humidity (RH) from 10% to 70%, or from 15% to 60% and a temperature from 10° C. to 60° C., or from 10° C. to 50° C., or from 10° C. to 25° C. for 24 hours to 336 hours. The moisture cure forms the crosslinked ethylene-Si polymer.

In an embodiment, moisture cure includes immersing the second composition in a water bath at a temperature from 20° C. to 90° C., or from 20° C. to 60° C., or from 20° C. to 50° C. for 24 hours to 168 hours. The moisture cure forms the crosslinked ethylene-Si polymer.

In an embodiment, the crosslinked ethylene-Si polymer is the moisture cure reaction product between (i) the functionalized ethylene-Si polymer containing Structure (1) and (ii) the cure catalyst DSBA, the reaction product forming a crosslinked ethylene-Si polymer having a Structure (2) below:

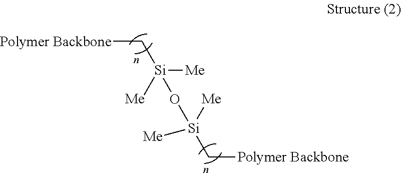

wherein
Me is a methyl group (CH₃), and
n is an integer from 4 to 6 (or 4, or 5, or 6).

In an embodiment, the first melt blending and/or the second melt blending is/are conducted by way of batch mixing in a batch mixer. For the first melt blending, the (i) ethylene-SiH polymer, (ii) the monoketone coagent, and (iii) the triarylborane, are introduced into a batch mixer and are melt blended, or otherwise mixed, at a temperature from 80° C. to 200° C., or from 90° C. to 150° C., or from 100° C. to 120° C. for 1 minute to 20 minutes, or from 2 minutes to 15 minutes, or from 3 minutes to 10 minutes. Nonlimiting examples of suitable batch mixers include a BANBURY™ mixer, a BOLLING™ mixer, or a HAAKE™ mixer. The batch mixing forms a functionalized ethylene-Si polymer. In an embodiment, the monoketone coagent is acetophenone and the batch mixing forms a functionalized ethylene-Si polymer with the Structure (1).

In an embodiment, the second melt blending is conducted by way of batch mixing in a batch mixer. For the second melt blending, the (iv) functionalized ethylene-Si polymer and (v) the cure catalyst are introduced into a batch mixer and are melt blended, or otherwise mixed, at a temperature from 80° C. to 200° C., or from 90° C. to 150° C., or from 100° C. to 120° C. for 1 minute to 20 minutes, or from 2 minutes to 15 minutes, or from 3 minutes to 10 minutes. Nonlimiting examples of suitable batch mixers include a BANBURY™ mixer, a BOLLING™ mixer, or a HAAKE™ mixer. The batch mixing forms the second composition that is subsequently moisture cured to form the crosslinked ethylene-Si polymer having the Structure (2).

In an embodiment, the first melt blending and/or the second melt blending is/are conducted by way of continuous mixing in an extruder. For the first melt blending, the (i) ethylene-SiH polymer, (ii) the monoketone coagent, and (iii) the triarylborane, are introduced into an extruder and melt blended, or otherwise mixed, at a temperature from 80° C. to 200° C., or from 90° C. to 150° C., or from 100° C. to 120° C. for 1 minute to 20 minutes, or from 2 minutes to 15 minutes, or from 3 minutes to 10 minutes to form a homogeneous composition. The extruder can be a continuous single screw extruder or a continuous twin screw extruder. Nonlimiting examples of suitable extruders include a FARREL™ continuous mixer, a COPERION™ twin screw extruder, or a BUSS™ kneading continuous extruder. The homogeneous composition exits an exit die of the extruder as an extrudate that is a functionalized ethylene-Si polymer. In an embodiment, the monoketone coagent is acetophenone and the homogeneous composition exits the exit die of the extruder as an extrudate that is a functionalized ethylene-Si polymer with the Structure (1).

In an embodiment, the second melt blending is conducted by way of continuous mixing in an extruder. For the second melt blending, the (iv) functionalized ethylene-Si polymer and (v) the cure catalyst are introduced into an extruder and melt blended, or otherwise mixed, at a temperature from 80° C. to 200° C., or from 90° C. to 150° C., or from 100° C. to 120° C. for 1 minute to 20 minutes, or from 2 minutes to 15 minutes, or from 3 minutes to 10 minutes to form a homogeneous composition. The extruder can be a continuous single screw extruder or a continuous twin screw extruder. Nonlimiting examples of suitable extruders include a FARREL™ continuous mixer, a COPERION™ twin screw extruder, or a BUSS™ kneading continuous extruder. The homogeneous composition exits an exit die of the extruder as an extrudate composed of the second composition, the extrudate subsequently moisture cured to form the crosslinked ethylene-Si polymer with the Structure (2).

In an embodiment, the process includes providing a first composition composed of (i) the ethylene-SiH polymer, (ii) the monoketone coagent, and (iii) the triarylborane. The ethylene-SiH polymer contains Si atoms present in the SiH comonomer. The monoketone coagent contains carbonyl moieties. A “carbonyl:SiH mole ratio,” as used herein, is the ratio of moles carbonyl groups present in the monoketone coagent to the moles of Si atoms present in the ethylene-SiH polymer. The process includes providing a first composition with components (i)-(iii) and having a carbonyl:SiH mole ratio from 0.25 to 2.5, or from 0.5 to 2.0, or from 0.50 to 1.5, and first melt blending the first composition at a temperature from 80° C. to 200° C. and forming a functionalized ethylene-Si polymer. In an embodiment, the monoketone coagent is acetophenone and the functionalized ethylene-Si polymer has the Structure (1). The functionalized ethylene-Si polymer (with Structure (1)) has a gel content from 0%, or from greater than 0% to less than 2.5%. The process further includes second melt blending the second composition of (iv) the functionalized ethylene-Si polymer (with Structure (1) and 0%, or greater than 0% to less than 2.5% gel content) and (v) the cure catalyst, and subsequently moisture curing the second composition to form the crosslinked ethylene-Si polymer with Structure (2).

In an embodiment, the process includes first melt blending, at a temperature from 80° C. to 200° C., or from 90° C. to 150° C., or from 100° C. to 120° C. for 1 minute to 20 minutes, or from 2 minutes to 15 minutes, or from 3 minutes to 10 minutes, a first composition comprising (i) from 95 wt % to 98 wt % an ethylene/α-olefin/—SiH terpolymer, (ii) from 1 wt % to 10 wt %, or from 3 wt % to 8 wt % of the monoketone coagent that is acetophenone, (iii) from 5 ppm to 5000 ppm, or from 10 ppm to 100 ppm of the trialkylborane, wherein the first composition has a carbonyl:SiH mole ratio from 0.25 to 2.5, or from 0.5-2.0, or from 0.5 to 1.5), and forming a functionalized ethylene Si—H polymer having the Structure (1) and a gel content from 0%, or from greater than 0% to less than 2.5%. The process further includes second melt blending a second composition composed of (iv) the functionalized ethylene-Si polymer and (v) a cure catalyst that is DBSA, the second composition (post-second melt blending) moisture cured to form the crosslinked ethylene-Si polymer having Structure (2).

The present disclosure provides a composition. In an embodiment, the composition includes a functionalized ethylene-Si polymer having the Structure (1)

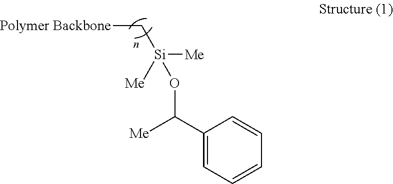

wherein
Me is a methyl group (CH₃), and
n is an integer from 4 to 6 (or 4, or 5, or 6).

The crosslinked ethylene-Si polymer with Structure (1) has one, some, or all of the following properties:
(i) a density from 0.86 g/cc to 0.88 g/cc, and/or
(ii) from 3000 ppm to 7000 ppm silicon atom, and/or
(iii) from 1 ppm to 10 ppm boron atom.

Applicant discovered a process that readily and predictably converts SiH groups to hydrolysable groups such as alkoxysilane and silyl ester by reacting the SiH moiety of the ethylene-SiH polymer with a carbonyl-containing co-agent (e.g., the monoketone, coagent) in the presence of a Lewis acid catalyst (e.g., triaryl borane). This method of post-polymerization functionalization can be applied to not only linear low-density polyethylene (LLDPE) but also low-density polyethylene (LDPE), and high-density polyethylene (HDPE). Further incorporation of a Brønsted acid catalyst (cure catalyst, such as DBSA) renders the resultant second composition curable when exposed to (atmospheric) moisture at ambient temperature to moderate temperatures (20° C. to 60° C.) and below the melting point of the ethylene-SiH polymer and/or below the melting point of the second composition). The ability of the present process to enable ambient cure is unexpected and is advantageous.

By way of example, and not limitation, some embodiments of the present disclosure will now be described in detail in the following examples.

### EXAMPLES

### 1. Materials

Materials used in the comparative samples (CS) and in the inventive examples (IE) are provided in Table 1 below.

TABLE 1
Materials

| Material | Product | | Source |
|---|---|---|---|
| Silane | HDMS (5- | | Gelest |
| Monomer | Hexenyldimethylsilane) (88%) | | |
| Silane | ODMS (7- | | Gelest |
| Monomer | Octenyldimethylsilane) (92%) | | |
| Solvent | Toluene | PhCH₃ | Sigma- |
| | | | Aldrich |
| Triarylborane | Tris(pentafluorophenyl)borane | B(C₆F₅)₃, (FAB) | Sigma- |
| (Lewis acid | (95%) | | Aldrich |
| catalyst) | | | |
| Cure catalyst | Dodecylbenzenesulfonic acid | n-C₁₂H₂₅PhS(═O)₂OH, (DBSA) | Sigma- |
| (Brønsted | (Mixture of isomers, ≥95%) | | Aldrich |
| acid catalyst) | | | |
| Peroxide | Dicumyl peroxide (98%) | PhC(CH₃)₂OOC(CH₃)₂Ph, (DCP) | Sigma- |
| | | | Aldrich |
| Coagent | Acetophenone (99%) | 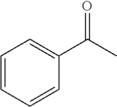 | Sigma- Aldrich |
| | | CH₃C(═O)Ph | |

### A. Syntheses of Polymers P1, P2, P3, P4, and P5 and Properties

The ethylene/octene/silane co-polymerizations to produce Polymer 1 (an ethylene-SiH polymer) were conducted in a batch reactor designed for ethylene homo-polymerizations and co-polymerizations. The reactor was equipped with electrical heating bands, and an internal cooling coil containing chilled glycol. Both the reactor and the heating/cooling system were controlled and monitored by a process computer. The bottom of the reactor was fitted with a dump valve, which emptied the reactor contents into a dump pot that was vented to the atmosphere. All chemicals used for polymerization and the catalyst solutions were run through purification columns prior to use. The ISOPAR-E, 1-octene, ethylene, and silane monomers were also passed through columns. Ultra-high purity grade nitrogen (Airgas) and hydrogen (Airgas) were used. The catalyst cocktail was prepared by mixing, in an inert glove box, the scavenger (MMAO), activator (bis(hydrogenated tallow alkyl)methyl tetrakis(pentafluoro-phenyl)borate(1<->) amine), and catalyst with the appropriate amount of toluene, to achieve a desired molarity solution. The solution was then diluted with ISOPAR-E or toluene to achieve the desired quantity for the polymerization, and drawn into a syringe for transfer to a catalyst shot tank.

In a typical polymerization, the reactor was loaded with ISOPAR-E, and 1-octene via independent flow meters. The silane monomer was then added via a shot tank piped in through an adjacent glove box. After the solvent/comonomer addition, hydrogen (if desired) was added, while the reactor was heated to a polymerization setpoint of 120° C. The ethylene was then added to the reactor via a flow meter, at the desired reaction temperature, to maintain a predetermined reaction pressure set point. The catalyst solution was transferred into the shot tank, via syringe, and then added to the reactor via a high pressure nitrogen stream, after the reactor pressure set point was achieved. A run timer was started upon catalyst injection, after which, an exotherm was observed, as well as a decrease in the reactor pressure, to indicate a successful run.

Ethylene was then added using a pressure controller to maintain the reaction pressure set point in the reactor. The polymerizations were run for set time or ethylene uptake, after which, the agitator was stopped, and the bottom dump valve was opened to empty the reactor contents into dump pot. The pot contents were poured into trays, which were placed in a fume hood, and the solvent was allowed to evaporate overnight. The trays containing the remaining polymer were then transferred to a vacuum oven, and heated to 100° C., under reduced pressure, to remove any residual solvent. After cooling to ambient temperature, the polymers were weighed for yield/efficiencies, transferred to containers for storage, and submitted for analytical testing.

The interpolymers Polymers 2-5 (ethylene-SiH polymers) were each prepared in a one gallon polymerization reactor that was hydraulically full, and operated at steady state conditions. The detailed synthesis information is provided for several of the listed examples. The solvent was ISOPAR-E, supplied by the ExxonMobil Chemical Company. 5-Hexenyldimethylsilane (HDMS) supplied by Gelest was used as a termonomer and was purified over AZ-300 alumina supplied by UOP Honeywell prior to use. HDMS was fed to the reactor as a 22 wt % solution in ISOPAR-E. The reactor temperature was measured at or near the exit of the reactor. The interpolymer was isolated and pelletized. Polymerization conditions are listed in Table 1C-1E, and catalysts are shown in Table 1B. The polymer properties for each ethylene-SiH polymer P1, P2, P3, P4, P5 are shown in Tables 2A and 2B.

TABLE 1A
Polymerization Conditions to produce Polymer 1

| | | | Reactor | Ethylene | Octene | Silane | Solvent | H₂ | |
|---|---|---|---|---|---|---|---|---|---|
| | | Reactor | Pressure | loaded | loaded | monomer | loaded | loaded | Run Time |
| Resin | Catalyst | Size | (psi) | (g) | (g) | loaded (g) | (g) | (mmol) | (min) |
| Polymer 1 | PE CAT 1 | 2 L | 113.2 | 12.5 | 41.8 | 6.1 | 582.3 | 11.2 | 5 |

TABLE 1B
Catalysts and co-catalysts

| Catalyst (CAT) | Description |
|---|---|
| PE CAT 1 (WO2012/027448) | 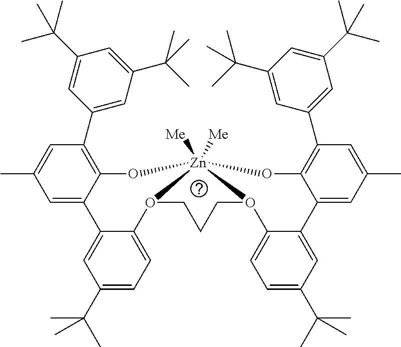 |
| PE CAT 2 (WO2012/027448) | 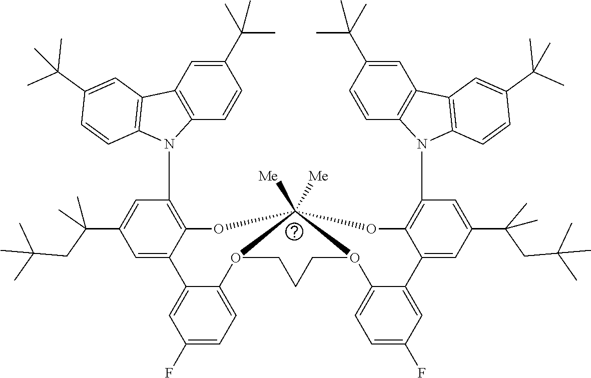 |
| Cocatalyst | |
| CoCAT-1 | A mixture of methyldi(C14-18 alkyl)ammonium salts of |
| | tetrakis(pentafluorophenyl)borate, prepared by reaction of a long chain |
| | trialkylamine (Armeen ™ M2HT, available from Akzo-Nobel, Inc.), HCl and |
| | Li[B(C6F5)4], substantially as disclosed in USP 5,919,983, Ex. 2 (no further |
| | purification performed) (Boulder Scientific) |
| CoCAT-2 | Modified methylalumoxane (MMAO) Type 3A (no further purification |
| | performed) (Akzo Nobel) |

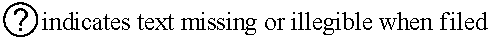

TABLE 1C
Polymerization Conditions to produce Polymers 2-5

| | Reactor | Reactor | | | | | | ethylene |
|---|---|---|---|---|---|---|---|---|
| | Temp., | Pressure, | Solvent, | Ethylene, | Octene, | HDMS, | Hydrogen, | conversion, |
| | ° C. | psig | lb/hr | lb/hr | lb/hr | lb/h | sccm | % |
| Polymer 4 | 170 | 729 | 38 | 3.8 | 5.0 | 1.4 | 192 | 83 |
| Polymer 2 | 168 | 726 | 36 | 3.8 | 5.0 | 2.9 | 193 | 82 |
| Polymer 5 | 170 | 727 | 16 | 3.6 | 4.4 | 2.7 | 89 | 90 |
| Polymer 3 | 170 | 728 | 39 | 3.8 | 5.4 | 0 | 162 | 83 |

TABLE 1D
Catalyst Feed Flows and Efficiency to produce Polymers 2-5

| | | | Catalyst | Overall Catalyst |
|---|---|---|---|---|
| | | Catalyst | Solution | Efficiency, (g |
| | | Solution | Metal | interpolymer/g total |
| | Catalyst | Flow, lb/hr | Conc., ppm* | catalyst metal) |
| Polymer 4 | PE CAT 2 | 0.33 | 3.96 | 3,911,000 |
| Polymer 2 | PE CAT 2 | 0.57 | 3.96 | 2,385,000 |
| Polymer 5 | PE CAT 1 | 0.14 | 14.68 | 2,724,000 |
| Polymer 3 | PE CAT 2 | 0.33 | 3.96 | 3,939,000 |

*The “ppm” amount based on the weight of the respective catalyst feed solution.

TABLE 1E
Cocatalyst Feed Flows to produce Polymers 2-5

| | CoCAT 1 | | | CoCAT 2 |
|---|---|---|---|---|
| | Solution | CoCAT 1 | CoCAT 2 | Solution |
| | Flow, | Solution | Solution | Conc., |
| | lb/hr | Conc., ppm* | Flow, lb/hr | ppm Al** |
| Polymer 2 | 0.58 | 31.25 | 0.53 | 32.2 |
| Polymer 3 | 0.33 | 31.25 | 0.31 | 32.2 |
| Polymer 4 | 0.34 | 31.25 | 0.30 | 32.2 |
| Polymer 5 | 0.20 | 154.8 | 0.21 | 14.2 |

*The “ppm” amount based on the weight of the co-catalyst feed solution.
**The “ppm” amount of Al based on the weight of the co-catalyst feed solution.

TABLE 2A
Polymer Properties

| Resin Description | | | | | | | |
|---|---|---|---|---|---|---|---|
| | | MI | | | Silane Information | | |
| | Density | (dg/ | Octene | Tₘ | Silane | Silane | Silane |
| Resin | (g/cc) | min) | (mol %) | (C.°) | Type | mol %* | wt %** |
| Polymer 1 | — | — | 11.7 | 63.4 | ODMS | 0.6 | 2.5 |
| Polymer 2 | 0.87 | 0.8 | 11.0 | 61.9 | HDMS | 1.0 | 3.5 |
| Polymer 3 | 0.87 | 1.2 | 12.0 | 58.3 | HDMS | — | — |
| Polymer 4 | 0.873 | 0.8 | 12.8 | 64.5 | HDMS | 0.4 | 1.5 |
| Polymer 5 | 0.876 | 20.0 | 9.1 | 74.1 | HDMS | 0.8 | 3.0 |

*Mol % silane based on total moles of monomers in polymer, and determined by 1H NMR
**Wt % silane calculated from the mol %, and based on the weight of the interpolymer.

TABLE 2B
Polymer Properties (Conventional GPC)

| Resin | Mn (kg/mol) | Mw (kg/mol) | Mw/Mn |
|---|---|---|---|
| Polymer 1 | 47 | 111 | 2.4 |
| Polymer 2 | 45 | 100 | 2.2 |
| Polymer 3 | 52 | 112 | 2.2 |
| Polymer 4 | 49 | 108 | 2.2 |
| Polymer 5 | 25 | 52 | 2.1 |

### B. Melt Blending

Moisture-curable material (IE1-13, CS1-2): (i) an ethylene-SiH polymer, (ii) monoketone coagent, and (iii) a FAB solution in toluene (75 mg/mL) (first composition) were fed sequentially into a torque rheometer (Haake™ Rheomix QC Lab Mixers or HAAKE™ Rheomix OS Lab Mixers, Thermal Scientific) equipped with a 20 mL or a 50 mL bowl and two roller rotors at 100° C. After addition of each component, the sample (first composition) was mixed at 60 rpm for 1 minute (min) (first melt blending). The final blend was mixed for another 4 minutes (first melt blending). The hot melt was then removed from the blender yielding a functionalized ethylene-Si polymer with the Structure (1). The SiH conversion of the functionalized Si—H polymer was analyzed using FTIR-ATR. A second composition was prepared by compounding (i) the functionalized ethylene-Si polymer (with Structure (1)), which was fed into a 20 mL bowl of a torque rheometer and melted at 100° C., and mixed at 60 rpm for 1 minute (second melt blending). Subsequently, cure catalyst DBSA was added, and the blend was mixed for 5 minutes (second melt blending) yielding the second composition. The second composition was compression molded into torsion bars (1.7 mm thickness) under 20,000 lbs of force at 90° C. for 4 minutes.

Thermal-curable material (CS3): POE pellets (98.2 wt %) were mixed with a curing additive (1.8 wt % dicumyl peroxide) in a sealable glass jar. The soaking process occurred via shaking and a 4-hour imbibition, until no liquid residuals were visually seen adhering to the glass jar. Afterwards, the imbibed sample was melt-blended in RSI RS5000, RHEOMIX 600 mixer with CAM blades at 100° C./30 rpm for six minutes. The hot sample was cooled in a Carver press (cooled platens) at 20,000 psi, for four minutes, to make a “pancake sample” for further testing. The final sample was compression molded into a plaque (1.7 mm thickness) under 20,000 lbs of force at 100° C. for 5 minutes.

### C. Moisture Cure

Moisture cure (IE1-13, CS1-2): the molded moisture-curable material (the torsion bars of 1.7 mm thickness composed of the second composition) was subjected to different moisture cure conditions: 1) 20° C., 50% relative humidity (RH); 2) 25° C., 16-25% RH; 3) 50° C., 6-9% RH; 4) 50° C. water bath; 5) 1% RH. Thermal cure (CS3): the molded thermal-curable material was heated at 180° C. for 10 minutes in a compression molder.

Amounts and ratios for components (i), (ii), (iii), (iv), and (v) in resultant formulations CS1-CS3 and IE1-IE15 are provided in Table 3 below.

TABLE 3

| | CS1 | CS2 | CS3 | IE1 | IE2 | IE3 | IE4 | IE5 | IE6 |
|---|---|---|---|---|---|---|---|---|---|
| Polymer | Polymer 1 | Polymer 2 | Polymer 3 | Polymer 2 | Polymer 2 | Polymer 2 | Polymer 2 | Polymer 2 | Polymer 2 |
| Melt index of | — | 0.8 | 1.2* | 0.8 | 0.8 | 0.8 | 0.8 | 0.8 | 0.8 |
| SiH-POE | | | | | | | | | |
| Mw (kda) | 111 | 100 | 112 | 100 | 100 | 100 | 100 | 100 | 100 |
| HDMS wt % | 2.5^{#} | 3.5 | n/a | 3.5 | 3.5 | 3.5 | 3.5 | 3.5 | 3.5 |
| HDMS (ppm) | 25000 | 35000 | n/a | 35000 | 35000 | 35000 | 35000 | 35000 | 35000 |
| Coagent | A | None | N/A | S | A | A | A | A | A |
| Coagent/SiH | 1 | — | N/A | 1 | 1 | 1 | 1 | 1 | 1 |
| (mol/mol) | | | | | | | | | |
| Coagent wt % | 1.76 | N/A | N/A | 7 | 3 | 3 | 3 | 3 | 3 |
| Coagent | 17647 | N/A | N/A | 70000 | 29577 | 29577 | 29577 | 29577 | 29577 |
| (ppm) | | | | | | | | | |
| FAB (ppm) | 500 | N/A | N/A | 500 | 500 | 500 | 500 | 500 | 500 |
| DBSA (ppm) | — | 2000 | 500 | 500 | 500 | 500 | 500 | 500 | 500 |
| Cure | 25 | 20 | 180 | 25 | 20 | 25 | 50 | 21 | 50 |
| temperature | | | | | | | | | |
| (° C.) | | | | | | | | | |
| Cure | 16-25 | 50 | n/a | 16-25 | 50 | 16-25 | 6-9 | 1 | N/A |
| humidity | | | | | | | | | |
| level (% RH) | | | | | | | | | |
| Water bath? | No | No | No | No | No | No | No | No | Yes |
| (Yes/no) | | | | | | | | | |
| | IE7 | IE8 | IE9 | IE10 | IE11 | IE12 | IE13 | IE14 | IE15 |
| Polymer | Polymer 2 | Polymer 2 | Polymer 2 | Polymer 2 | Polymer 2 | Polymer 4 | Polymer 5 | Polymer 2 | Polymer 2 |
| Melt index of | 0.8 | 0.8 | 0.8 | 0.8 | 0.8 | 0.8 | 20 | 0.8 | 0.8 |
| SiH-POE | | | | | | | | | |
| Mw (kda) | 100 | 100 | 100 | 100 | 100 | 108 | 52 | 100 | 100 |
| HDMS wt % | 3.5 | 3.5 | 3.5 | 3.5 | 3.5 | 1.5 | 3 | 3.5 | 3.5 |
| HDMS (ppm) | 35000 | 35000 | 35000 | 35000 | 35000 | 15000 | 30000 | 35000 | 35000 |
| Coagent | A | A | A | A | A | A | A | A | A |
| Coagent/SiH | 1 | 1 | 1 | 0.5 | 1.5 | 1 | 1 | 0.5 | 1.5 |
| (mol/mol) | | | | | | | | | |
| Coagent wt % | 3 | 3 | 3 | 3 | 3 | 1 | 3 | 1 | 4 |
| Coagent | 29577 | 29577 | 29577 | 29577 | 29577 | 12676 | 25352 | 14789 | 44366 |
| (ppm) | | | | | | | | | |
| FAB (ppm) | 500 | 500 | 50 | 500 | 500 | 500 | 500 | 500 | 500 |
| DBSA (ppm) | 500 | 2000 | 500 | 500 | 500 | 500 | 500 | 500 | 500 |
| Cure | 20 | 20 | 20 | 20 | 20 | 20 | 20 | 20 | 20 |
| temperature | | | | | | | | | |
| (° C.) | | | | | | | | | |
| Cure | 50 | 50 | 50 | 50 | 50 | 50 | 50 | 50 | 50 |
| humidity | | | | | | | | | |
| level (% RH) | | | | | | | | | |
| Water bath? | No | No | No | No | No | No | No | No | No |
| (Yes/no) | | | | | | | | | |

*CS3 has no SiH comonomer, CS3 is ethylene/C8 α-olefin copolymer, with 1.8 wt % DCP and 500 ppm DBSA, thermal cured at 180° C. for 10 min
^{#}CS1 contains 2.5 wt % ODMS, no HDMS
A—acetophenone

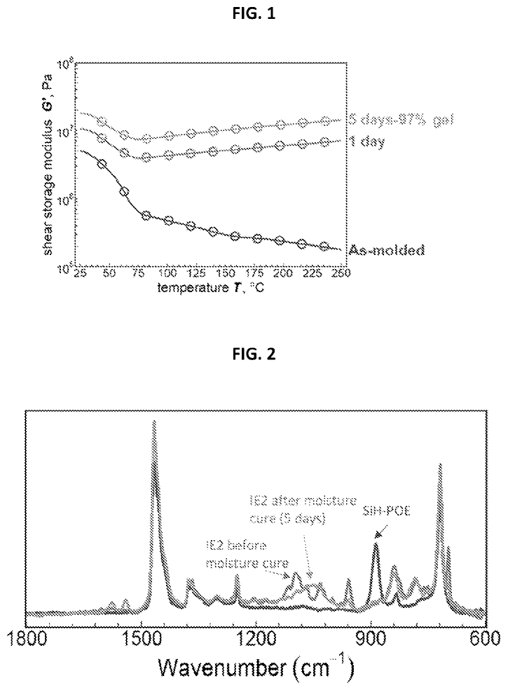

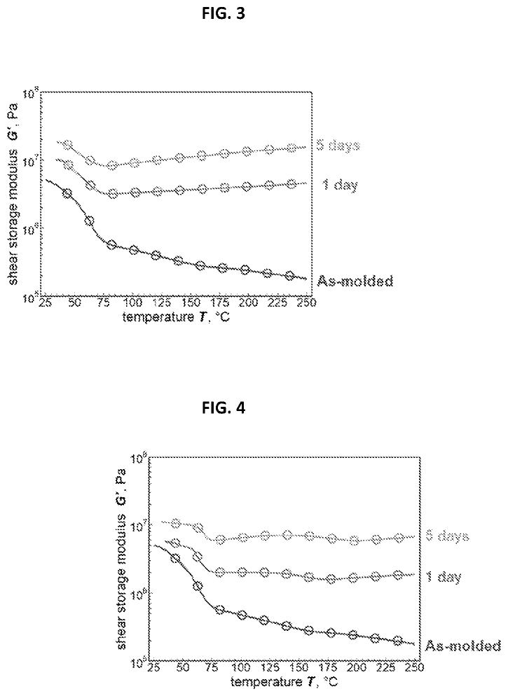

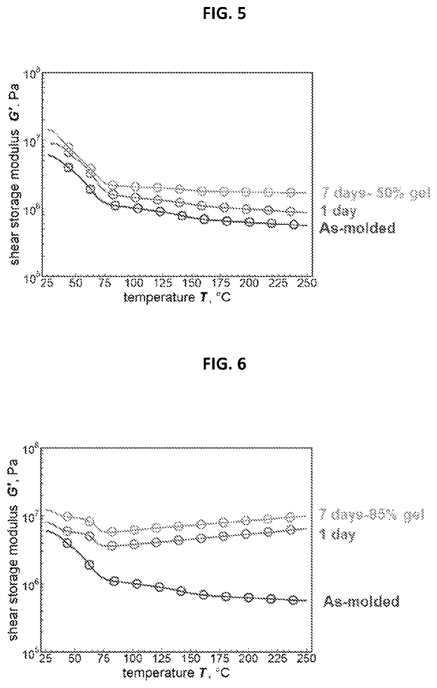

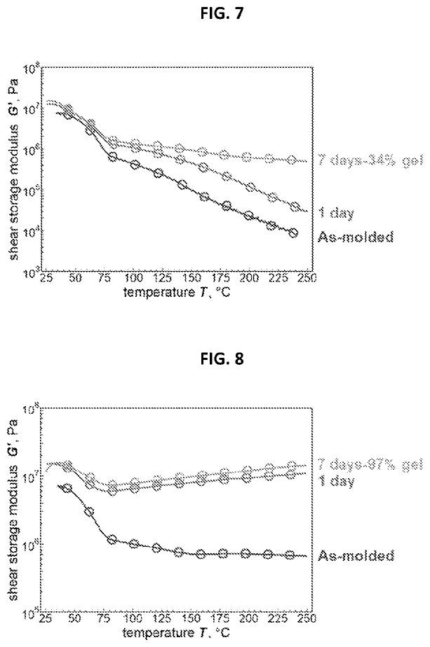

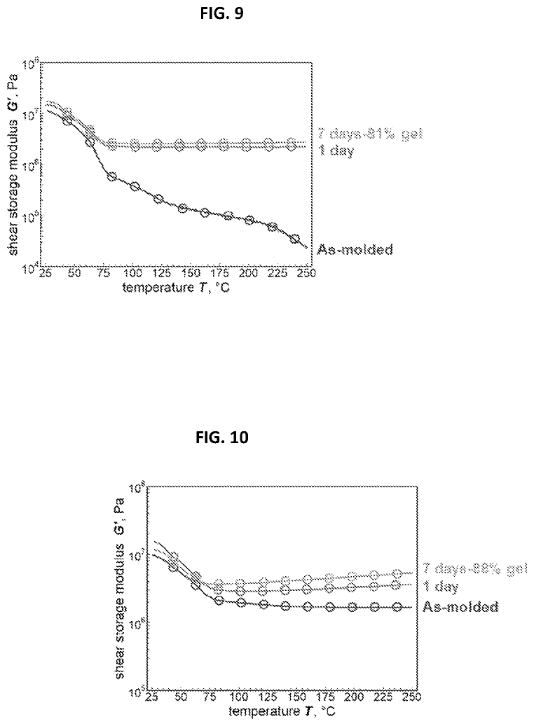

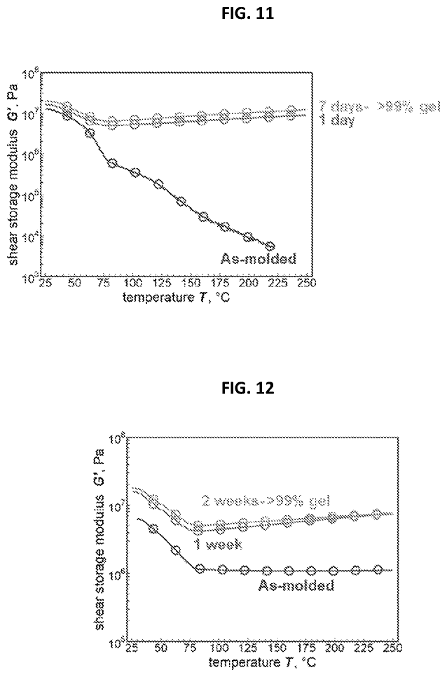

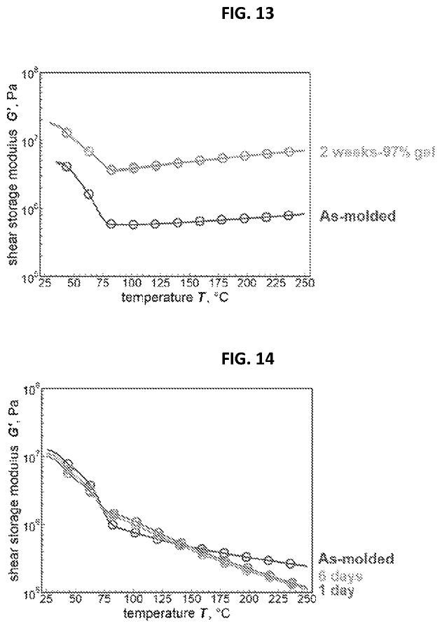

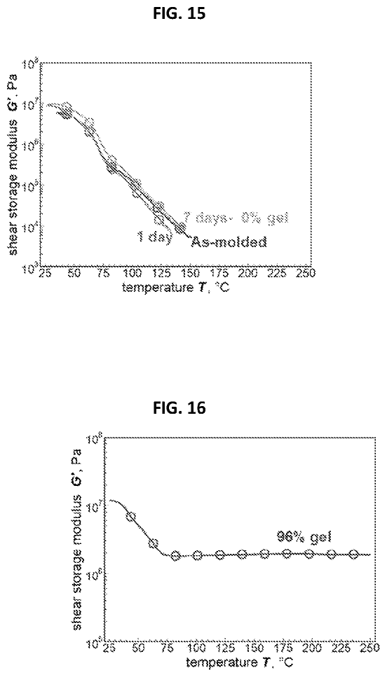

TABLE 4

| | | G′ | Gel | G′ | G′ | Gel | G′ | G′ | Gel | G′ | Gel |
|---|---|---|---|---|---|---|---|---|---|---|---|
| | | (MPa) | (wt %) | (MPa) | (Mpa) | (wt %) | (MPa) | (Mpa) | (wt %) | (MPa) | (wt %) |
| | Corresponding | as | (as | (1 | (5 | (5 | 6 | (7 | (7 | (14 | (14 |
| Example | FIG. | molded | molded) | day) | days) | days) | days) | days) | days) | days) | days) |
| IE2 | FIG. 1 | 0.5 | — | 4.2 | 8.0 | 97 | — | — | — | — | — |
| IE3 | FIG. 3 | 0.5 | — | 2.2 | 9.3 | — | — | — | — | — | — |
| IE4 | FIG. 4 | 0.5 | — | 1.0 | — | — | — | 5.2 | — | — | — |
| IE5 | FIG. 5 | 1.0 | — | 1.3 | — | — | — | 2.0 | 50 | — | — |
| IE6 | FIG. 6 | 1.0 | — | 3.7 | — | — | — | 6.0 | 95 | — | — |
| IE7 | FIG. 7 | 0.3 | — | 1.0 | — | — | — | 1.3 | 34 | — | — |
| IE8 | FIG. 8 | 1.0 | — | 6.1 | — | — | — | 7.8 | 97 | — | — |
| IE9 | FIG. 9 | 0.4 | — | 2.1 | — | — | — | 2.4 | 81 | — | — |
| IE10 | FIG. 10 | 2.0 | — | 2.9 | — | — | — | 3.7 | 88 | — | — |
| IE11 | FIG. 11 | 0.4 | — | 4.0 | — | — | — | 5.8 | >99 | — | — |
| IE12 | FIG. 12 | 1.2 | — | — | — | — | — | 4.2 | — | 5.1 | >99 |
| IE13 | FIG. 13 | 0.6 | — | — | — | — | — | — | — | 3.8 | 97 |
| CS1 | FIG. 14 | 0.8 | — | 1.0 | — | — | 1.1 | — | — | — | — |
| CS2 | FIG. 15 | 0.1 | — | 0.1 | — | — | — | 0.2 | 0 | — | — |
| CS3 | FIG. 16 | 1.7* | 96.0 | — | — | — | — | — | — | — | — |

FIG. 1 shows temperature dependence of storage modulus (G′) of a composition using acetophenone (IE2) as the coagent before and after moisture cure at 20° C., 50% RH. G′ of the material increased over time, and the high-temperature plateau of storage modulus suggests formation of a crosslinked 3-dimensional network after moisture cure, which is further confirmed by gel content of 97%. FTIR-ATR showed quantitative conversion of SiH in the functionalized ethylene-Si polymer to alkoxysilane by mixing ethylene-SiH polymer and acetophenone in the presence of FAB, as indicated by disappearance of the SiH peak at ^{˜}890 cm⁻¹ and appearance of an SiOC peak at ^{˜}1100 cm⁻¹ (FIG. 2). The new peak at ^{˜}960 cm⁻¹ can also be assigned to the resultant silyl ether structure. After exposure to moisture for 5 days (moisture cure), both peaks at 960 cm⁻¹ and 1100 cm⁻¹ largely decreased. Meanwhile, a peak associated with Si—O—Si appeared at ^{˜}1060 cm⁻¹, indicating formation of siloxane crosslinkages under ambient conditions.

FIGS. 3-13 show temperature dependence of storage modulus (G′) of different compositions (IE3-13) using acetophenone as the coagent before and after moisture cure at various conditions. In most cases, G′ of the material increased over time as a result of sample cure. The positive slope of the plateau storage modulus indicates that these materials had formed a rubber-like network. Despite slower cure of IE7 that contains 500 ppm DBSA (FIG. 7), IE7 still reached 34% gel content after 2 weeks.

FIG. 14 shows temperature dependence of storage modulus (G′) of a composition containing no DBSA (CS1) after exposed to moisture cure conditions. Little change was observed after 6 days, suggesting that the use of a Brönsted acid (cure catalyst) as a moisture cure catalyst is necessary.

FIG. 15 shows temperature dependence of storage modulus (G′) of a composition containing only SiH-POE and DBSA (CS2). Little change was observed after 7 days, suggesting that conversion of SiH to silyl ether or silyl ester is mandatory for the moisture cure to occur under ambient conditions.

Dicumyl peroxide (DCP) is commonly used to cure polyolefin elastomers by a radical mechanism. FIG. 16 shows temperature dependence of storage modulus (G′) of a peroxide-cured POE (CS3), whose plateau G′ was much lower than that of a moisture-cured material due to a lower degree of chemical crosslinking.

It is specifically intended that the present disclosure not be limited to the embodiments and illustration contained herein, but include modified forms of those embodiments including portions of the embodiments and combination of elements of different embodiments as come within the scope of the following claims.

1. A process comprising:
first melt blending, at a temperature from 80° C. to 200° C., a first composition comprising
(i) an ethylene-SiH polymer,
(ii) a coagent that is a monoketone, and
(iii) a triarylborane;
forming a functionalized ethylene-Si polymer;
second melt blending, at a temperature from 80° C. to 200° C., a second composition comprising
(iv) the functionalized ethylene-Si polymer, and
(v) a cure catalyst;
moisture curing the second composition; and
forming a crosslinked ethylene-Si polymer.

2. The process of claim 1 comprising
providing a first composition having a carbonyl:SiH mole ratio from 0.25 to 2.5; and
forming a functionalized ethylene-SiH polymer having a gel content from 0% to less than 2.5%.

3. The process of claim 1 comprising
providing a first composition comprising
(i) from 95 wt % to 98 wt % an ethylene/α-olefin/—SiH terpolymer,
(ii) from 2 wt % to 5 wt % of the coagent,
(iii) from 5 ppm to 500 ppm of the trialkyl borane.

4. The process of claim 1 comprising forming a functionalized ethylene-SiH polymer having Si—O—C bonds.

5. The process of claim 1 comprising forming a functionalized ethylene-SiH polymer having a Structure (1) 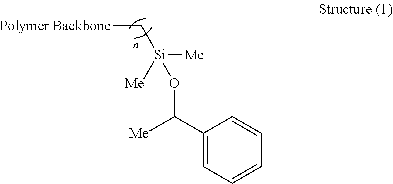
wherein n is an integer from 4 to 6.

6. The process of claim 1 comprising providing a second composition comprising
(iv) from 95 wt % to 98 wt % of the functionalized ethylene/α-olefin/—SiH terpolymer, and
(v) from 100 ppm to 2000 ppm of the cure catalyst;
moisture curing the second composition; and
forming a crosslinked ethylene-Si polymer having Si—O—Si bonds.

7. The process of claim 6 comprising forming a crosslinked ethylene-SiH polymer having a Structure (2) 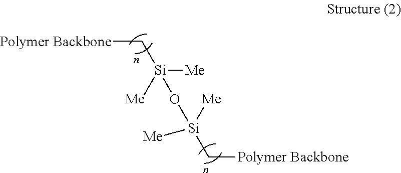
wherein is an integer from 4 to 6.

8. A composition comprising:
a functionalized ethylene-Si polymer having a Structure (1) 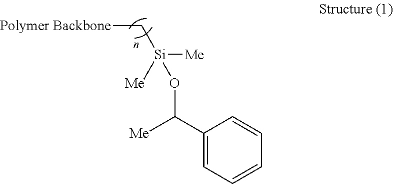
wherein n is an integer from 4 to 6.

9. The composition of claim 8 wherein the composition has a density from 0.86 g/cc to 0.88 g/cc.

10. The composition of claim 8 comprising from 3000 ppm to 7000 ppm silicon atom.

11. The composition of claim 8 comprising from 1 ppm to 10 ppm boron atom.
